(19) United States
(12) Patent Application Publication
(10) Pub. No.: US 2025/0036309 A1
(43) Pub. Date: Jan. 30, 2025

(54) IMPROVING SOFTWARE COMPRESSION EFFICIENCY FOR MEMORY-RESTRICTED DEVICES USING A SCRATCH BUFFER

(71) Applicant: Aurora Labs Ltd., Tel Aviv (IL)

(72) Inventor: Avraham Bernstein, Jerusalem (IL)

(73) Assignee: Aurora Labs Ltd., Tel Aviv (IL)

(21) Appl. No.: 18/588,475

(22) Filed: Feb. 27, 2024

Related U.S. Application Data
(60) Provisional application No. 63/515,240, filed on Jul. 24, 2023.

(51) Int. Cl. G06F 3/06

(52) U.S. Cl. CPC G06F 3/0656; G06F 3/0608; G06F 3/0679

(57) ABSTRACT

Disclosed herein are techniques for improving data compression efficiency for RAM-restricted devices. Techniques include allocating a scratch buffer within a first memory space of a controller; storing a particular portion of a chunk of software change elements in the scratch buffer; flushing the particular portion of the chunk from the scratch buffer to a second memory space; storing at least one subsequent portion of the chunk in the scratch buffer; flushing the at least one subsequent portion of the chunk from the scratch buffer to a second memory space of the controller; and applying, using the flushed first and at least one subsequent portion of the chunk, the software change elements to the controller.

### CROSS-REFERENCE TO RELATED APPLICATIONS

This application claims priority to U.S. Provisional Patent App. No. 63/515,240, filed on Jul. 24, 2023, which is incorporated herein by reference in its entirety.

### TECHNICAL FIELD

The subject matter described herein generally relates to techniques for improving software updates and data transfer for random-access memory-restricted (RAM-restricted) devices. Such techniques may be applied to vehicle software and systems, as well as to various other types of Internet-of-Things (IoT) or network-connected systems that utilize controllers such as electronic control units (ECUs) or other controllers or devices. For example, certain disclosed embodiments are directed to intelligently allocating a scratch buffer and using the scratch buffer to store a software chunk.

### BACKGROUND

Many Internet-of-Things (IoT) devices rely on relatively small random access memories (RAMs), which can limit the ability of these devices to install software updates. Even when these devices can install an update, their limited RAM spaces may limit the efficiency of the update. Further, RAM in IoT devices can be challenging to update in dynamic environments (e.g., during live operation, or during deployment, etc.). It can also be error-prone and inefficient when performing such updates remotely (e.g., wirelessly).

In view of the technical deficiencies of current systems, there is a need for improved systems and methods for providing intelligent software updating and data transfer for computing devices and systems. The techniques discussed below offer many technological improvements in speed, efficiency, verifiability, and usability. For example, according to some techniques, a scratch buffer may be intelligently allocated within a first memory space of a controller from which chunk portions may be flushed to a second memory space, resulting in improved data compression efficiency. These and other technical advancements and advantages are discussed below.

### SUMMARY

Some disclosed embodiments describe non-transitory computer-readable media, systems, and methods for improving data compression efficiency for RAM-restricted devices. For example, in an exemplary embodiment, a method may include allocating a scratch buffer within a first memory space of a controller; storing a particular portion of a chunk of software change elements in the scratch buffer; flushing the particular portion of the chunk from the scratch buffer to a second memory space; storing at least one subsequent portion of the chunk in the scratch buffer; flushing the at least one subsequent portion of the chunk from the scratch buffer to a second memory space of the controller; and applying, using the flushed first and at least one subsequent portion of the chunk, the software change elements to the controller.

In accordance with further embodiments, the first memory space exists in random access memory (RAM).

In accordance with further embodiments, the second memory space exists in flash memory.

In accordance with further embodiments, a size of the chunk is a multiple of a page size associated with the flash memory.

In accordance with further embodiments, a size of the scratch buffer is a multiple of a page size associated with the flash memory.

In accordance with further embodiments, storing the particular portion of the chunk at the scratch buffer comprises trapping the particular portion of the chunk.

In accordance with further embodiments, trapping the particular portion of the chunk comprises executing a trapping function configured to trap chunk portions.

In accordance with further embodiments, the trapping function is not configured to trap an entire chunk.

In accordance with further embodiments, the controller includes an initial function; the method further comprises storing the trapping function on the controller; and flushing the particular portion of the chunk from the scratch buffer to the second memory space comprises executing the trapping function instead of the initial function.

In accordance with further embodiments, the software change elements include a software change file representing a change to software of the controller.

In accordance with further embodiments, the software change elements include a delta file.

In accordance with further embodiments, the particular portion of the chunk and the at least one subsequent portion of the chunk are extracted from the delta file by the controller.

In accordance with further embodiments, the method further includes storing dictionary information in the first memory space according to at least one location determination parameter usable to determine a dictionary information storage location that will increase an overlay region width.

In accordance with further embodiments, the method further includes dynamically partitioning and overlaying the first memory space.

In accordance with further embodiments, dynamically partitioning and overlaying the first memory space is based on metadata associated with the chunk.

In accordance with further embodiments, a size of the scratch buffer is smaller than the size of the chunk.

In accordance with further embodiments, the chunk is one megabyte or less in size.

Further disclosed embodiments include a non-transitory computer-readable medium which may include instructions that, when executed by at least one processor, cause the at least one processor to perform operations for improving data compression efficiency for RAM-restricted devices. The operations may include allocating a scratch buffer within a first memory space of a controller; storing a particular portion of a chunk of software change elements in the scratch buffer; flushing the particular portion of the chunk from the scratch buffer to a second memory space; storing at least one subsequent portion of the chunk in the scratch buffer; flushing the at least one subsequent portion of the chunk from the scratch buffer to a second memory space of the controller; and applying, using the flushed first and at least one subsequent portion of the chunk, the software change elements to the controller.

In accordance with further embodiments, the first memory space exists in random access memory (RAM).

In accordance with further embodiments, the second memory space exists in flash memory.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 illustrates an exemplary pictographic representation of a network architecture for providing memory efficiency benefits to devices, consistent with embodiments of the present disclosure.

FIG. 2 illustrates an exemplary pictographic representation of a computing device, consistent with embodiments of the present disclosure.

FIG. 3 depicts a flowchart of an exemplary process for improving data compression efficiency for RAM-restricted devices, consistent with embodiments of the present disclosure.

FIG. 4 illustrates an exemplary pictographic temporal representation of a data transfer environment, consistent with disclosed embodiments.

### DETAILED DESCRIPTION OF EXEMPLARY EMBODIMENTS

Reference will now be made in detail to exemplary embodiments, examples of which are illustrated in the accompanying drawings and disclosed herein. Wherever convenient, the same reference numbers will be used throughout the drawings to refer to the same or like parts. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

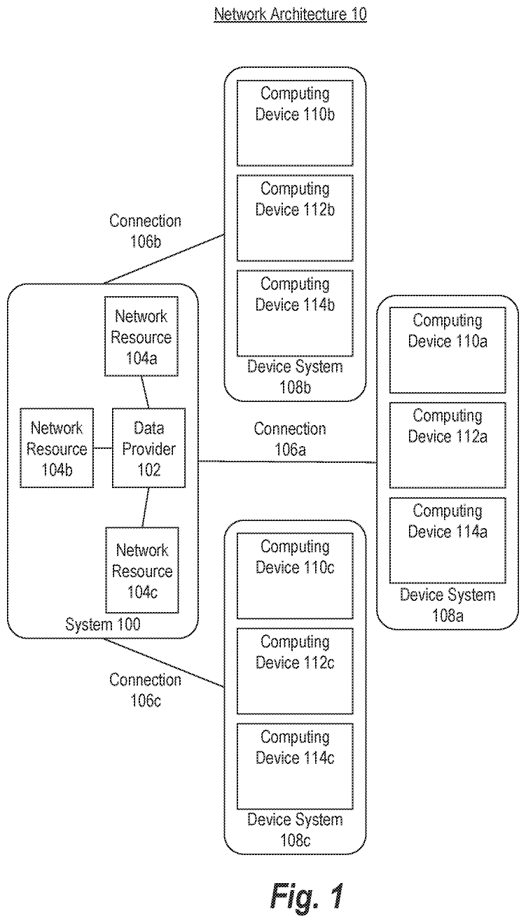

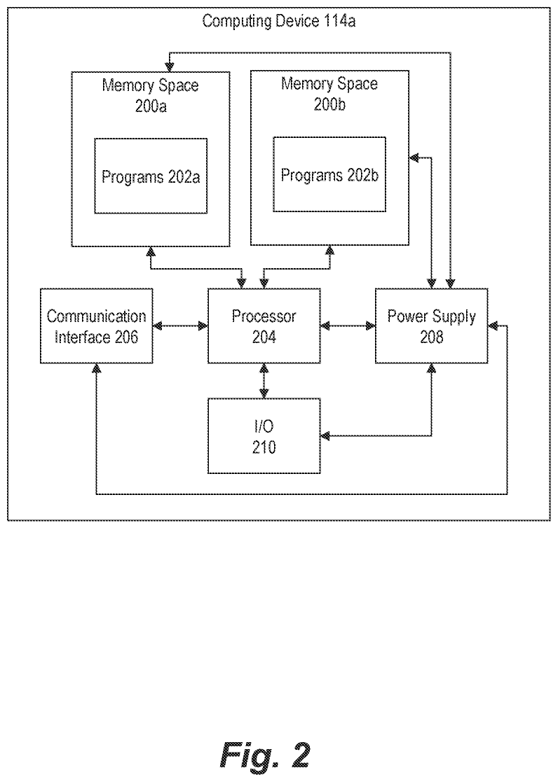

FIG. 1 illustrates an exemplary pictographic representation of network architecture 10, which may include a system 100. System 100 may be maintained, for example, by an artificial intelligence (AI) analysis provider, a security provider, software developer, an entity associated with developing or improving computer software, or any combination of these entities. System 100 may include a data provider 102, which may be a single device or combination of devices, and is described in further detail with respect to FIG. 2. Data provider 102 may be in communication with any number of network resources, such as network resources 104a, 104b, and/or 104c. A network resource may be a database, supercomputer, general purpose computer, special purpose computer, virtual computing resource (e.g., a virtual machine or a container), graphics processing unit (GPU), or any other data storage or processing resource.

Network architecture 10 may also include any number of device systems, such as device systems 108a, 108b, and 108c. A device system may be, for example, a computer system, a home security system, a parking garage sensor system, a vehicle, an inventory monitoring system, a connected appliance, telephony equipment, a network routing device, a smart power grid system, a drone or other unmanned vehicle, a hospital monitoring system, any Internet of Things (IoT) system, or any arrangement of one or more computing devices. A device system may include devices arranged in a local area network (LAN), a wide area network (WAN), or any other communications network arrangement. Further, each controller system may include any number of devices, such as controllers. For example, exemplary device system 108a includes computing devices 110a, 112a, and 114a, which may have the same or different functionalities or purposes. These devices are discussed further through the description of exemplary computing device 114a, discussed with respect to FIG. 2. Device systems 108a, 108b, and 108c may connect to system 100 through connections 106a, 106b, and 106c, respectively. A connection 106 (exemplified by connections 106a, 106b, and 106c) may be a communication channel, which may include a bus, a cable, a wireless (e.g., over-the-air) communication channel, a radio-based communication channel, a local area network (LAN), the Internet, a wireless local area network (WLAN), a wide area network (WAN), a cellular communication network, or any Internet Protocol (IP) based communication network and the like. Connections 106a, 106b, and 106c may be of the same type or of different types, and may include combinations of types (e.g., the Internet and a LAN).

Any combination of components of network architecture 10 may perform any number of steps of the exemplary processes discussed herein, consistent with the disclosed exemplary embodiments.

FIG. 2 illustrates an exemplary pictographic representation of computing device 114a, which may be a computer, a server, an IoT device, or a controller. For example, computing device 114a may be an automotive controller, such as an electronic control unit (ECU) (e.g., manufactured by companies such as Bosch™ Delphi Electronics™, Continenta™, Denso™, etc.), or may be a non-automotive controller, such as an IoT controller manufactured by Skyworks™, Qorvo™ Qualcomm™, NXP Semiconductors™, etc. Computing device 114a may be configured (e.g., through programs 202) to perform a single function (e.g., a braking function in a vehicle), or multiple functions. Computing device 114a may perform any number of steps of the exemplary processes discussed herein, consistent with the disclosed exemplary embodiments.

Computing device 114a may include a memory space 200a and a processor 204. Memory space 200b may include any feature of memory space 200a, as discussed below. Memory space 200a may include a single memory component, or multiple memory components. Such memory components may include an electronic storage device, a magnetic storage device, an optical storage device, an electromagnetic storage device, a semiconductor storage device, or any suitable combination of the foregoing. For example, memory space 200a may include any number of hard disks, solid state memories, random access memories (RAMs), read-only memories (ROMs), erasable programmable read-only memories (EPROMs or Flash memories), and the like. Memory space 200a may include one or more storage devices configured to store instructions usable by processor 204 to perform functions related to the disclosed embodiments. For example, memory space 200a may be configured with one or more software instructions, such as software program(s) 202 or code segments that perform one or more operations when executed by processor 204 (e.g., the operations discussed in connection with figures below). The disclosed embodiments are not limited to separate programs or computers configured to perform dedicated tasks. For example, memory space 200a may include a single program or multiple programs that perform the functions associated with network architecture 10. Memory space 200a may also store data that is used by one or more software programs (e.g., data relating to controller functions, data obtained during operation of the vehicle, or other data).

In certain embodiments, memory space 200a may store software executable by processor 204 to perform one or more methods, such as the methods discussed below. The software may be implemented via a variety of programming techniques and languages, such as C or MISRA-C, ASCET, Simulink, Stateflow, and various others. Further, it should be emphasized that techniques disclosed herein are not limited to automotive embodiments. Various other IoT environments may use the disclosed techniques, such as smart home appliances, network security or surveillance equipment, smart utility meters, connected sensor devices, parking garage sensors, and many more. In such embodiments, memory space 200a may store software based on a variety of programming techniques and languages such as C, C+, C++, C#, PHP, Java, JavaScript, Python, and various others.

Processor 204 may include one or more dedicated processing units, application-specific integrated circuits (ASICs), field-programmable gate arrays (FPGAs), graphical processing units, or various other types of processors or processing units coupled with memory space 200a.

Computing device 114a may also include a communication interface 206, which may allow for remote devices to interact with computing device 114a. Communication interface 206 may include an antenna or wired connection to allow for communication to or from computing device 114a. For example, an external device (such as computing device 114b, computing device 116a, data provider 102, or any other device capable of communicating with computing device 114a) may send code to computing device 114a instructing computing device 114a to perform certain operations, such as changing software stored in memory space 200a.

Computing device 114a may also include power supply 208, which may be an AC/DC converter, DC/DC converter, regulator, or battery internal to a physical housing of computing device 114a, and which may provide electrical power to computing device 114a to allow its components to function. In some embodiments, a power supply 208 may exist external to a physical housing of a computing device (i.e., may not be included as part of computing device 114a itself), and may supply electrical power to multiple computing devices (e.g., all controllers within a controller system, such as a device system 108a).

Computing device 114a may also include input/output device (I/O) 210, which may be configured to allow for a user or device to interact with computing device 114a. For example, I/O 210 may include at least one of wired and/or wireless network cards/chip sets (e.g., WiFi-based, cellular based, etc.), an antenna, a display (e.g., graphical display, textual display, etc.), an LED, a router, a touchscreen, a keyboard, a microphone, a speaker, a haptic device, a camera, a button, a dial, a switch, a knob, a transceiver, an input device, an output device, or another I/O device configured to perform, or to allow a user to perform, any number of steps of the methods of the disclosed embodiments, as discussed further below. While FIG. 2 depicts exemplary computing device 114a, these described aspects of computing device 114a (or any combination thereof) may be equally applicable to any other device in a network architecture, such as computing device 110b, computing device 110c, data provider 102, or network resource 104a.

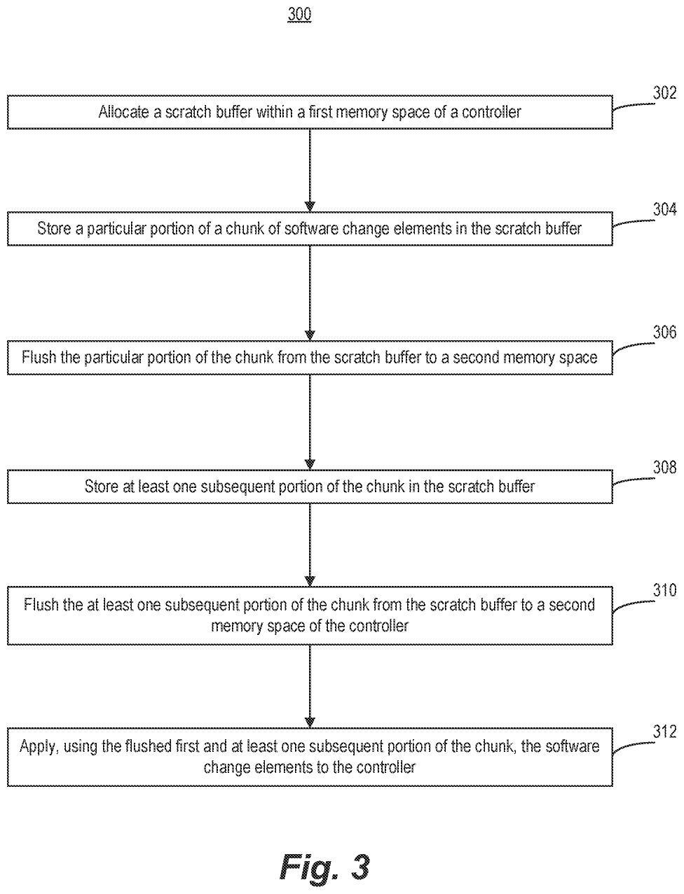

FIG. 3 is a flowchart of an example process 300 for improving data compression efficiency for RAM-restricted devices. In accordance with disclosed embodiments, process 300 may be implemented in system 100 depicted in FIG. 1, or any type of network environment. For example, process 300 may be performed by at least one processor (e.g., processor 204), memory (e.g., within memory space 200a), and/or other components of computing device 114a, or by any computing device or IoT system. Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

As shown in FIG. 3, process 300 may include allocating a scratch buffer within a first memory space of a controller (block 302). A memory space (e.g., memory space 200a) may include one or more areas configured for digital storage of information across one or more memory components. In some embodiments, the first memory space may exist in random access memory (RAM). The first memory space may be considered small (e.g., less than one megabyte, less than 384 kilobytes, less than 256 kilobytes) and/or smaller relative to a second memory space (e.g., a flash memory, which may have, for example, several megabytes of space). A scratch buffer may include a portion of memory (e.g., of the memory space) that is configured to store particular data (e.g., data for changing software on the controller), to store data for a particular purpose (e.g., changing software on the controller), and/or to store data for a particular time period (e.g., during a software change process for the controller). For example, a scratch buffer may be configured to temporarily store data for updating (or downgrading, or otherwise altering) software on the controller. Allocating the scratch buffer may also include identifying, delimiting, reserving, cleaning, or preparing a portion of memory for storage of data (e.g., incoming data).

In some embodiments, a size of the scratch buffer may be smaller than a chunk (discussed further herein). In some embodiments, the scratch buffer may be allocated to be a particular fractional amount of the chunk. For example, the scratch buffer may be one half the size of the chunk, one quarter the size of the chunk, or any other fractional size of the chunk. In some embodiments, a size of the scratch buffer may be a multiple of a page size associated with a second memory space (discussed further herein), which may be a flash memory. A page size may include an amount of data that a memory space is configured to designate as a page. By way of example, a memory space may be configured to designate 256 bytes as a page, and the size of the scratch buffer may be 512 bytes, 768 bytes, 1,024 bytes, or any multiple of 256.

As also shown in FIG. 3, process 300 may include storing a particular portion of a chunk of software change elements in the scratch buffer (block 304). Software change elements may include a program, a file, a portion of a file, a packet, code (e.g., computing code), data, or any digital information usable to change software on a computing device (e.g., a controller). In some embodiments, the software change elements may be or represent an update, downgrade, or any change to software on a device (e.g., a controller). For example, the software change elements may include a software change file representing a change to software of the controller. In some embodiments, the software change elements may include a delta file.

A chunk may include a particular division of data (e.g., the software change elements) made according to a predetermined value, which may be determined according to a technical standard, a firmware setting, an operating system (OS) setting, or developer setting, etc. For example, the software change elements may be divided into multiple chunks, which may have equal sizes. In some embodiments, a size for a chunk may be defined in a data structure, which may be present at the controller and/or included with the software change elements. In some embodiments, a size of the chunk may be a multiple of a page size associated with a second memory space (discussed further herein), which may be a flash memory. By way of example, a memory space may be configured to designate 256 bytes as a page, and the size of the chunk may be 512 bytes, 768 bytes, 1,024 bytes, or any multiple of 256. In some embodiments, the chunk may be one megabyte or less in size. It is appreciated that a chunk may be any number of sizes (e.g., 1 kilobyte, 10 kilobytes, 500 kilobytes, 5 megabytes, etc.). In some embodiments, a size of the chunk may be related to (e.g., based on) an amount of available memory (e.g., RAM) for processing the chunk. For example, a chunk may have a size that is as large as possible based on the amount of available memory for processing the chunk.

In some embodiments, the particular portion of the chunk may be requested and/or received by a device (e.g., a controller with a first and second memory space), such as prior to storing the particular portion of the chunk at the scratch buffer. In some embodiments, a chunk or portions of a chunk may be sent over the air to a device (e.g., from system 100 to computing device 114a). Alternatively, a file, such as a patch file (e.g., a binary and/or compressed patch file) may be received (e.g., from system 100) and may be sent over the air to a device (e.g., a controller), from which the device may extract a chunk (e.g., according to aspects of process 300). In some embodiments, a chunk, portions of a chunk, or a file may be sent over the air to a first device (e.g., a main computer of device system 108b), which may be transferred (e.g., in the same form, in an uncompressed form, etc.) to a second device (e.g., computing device 114b, which may be a controller).

In some embodiments, storing the particular portion of the chunk at the scratch buffer may include trapping the particular portion of the chunk. Trapping the portion may include executing one or more functions (e.g., by at least one processor of the controller) to prevent or delay an action (e.g., programmed action) from routing the particular portion of the chunk out of the scratch buffer. For example, trapping the particular portion of the chunk may comprise executing a trapping function configured to trap chunk portions. In some embodiments, the trapping function may not be configured to trap an entire chunk. In some embodiments, a device (e.g., a controller) may be configured (e.g., reconfigured from a default configuration) to trap a particular portion of a chunk. For example, a controller may include an initial function (e.g., memcpy, strcpy) and process 300 may further include storing the trapping function on the controller. In some embodiments, the trapping function may include a same signature (e.g., set of arguments, parameters, input value types, etc.) as the initial function. In some embodiments, the controller may be configured to execute the trapping function in place of the initial function. For example, when the trapping function is installed on the controller, it may prevent the initial function from executing, or reduce the contexts in which the initial function can execute.

In some embodiments, flushing the particular portion of the chunk from the scratch buffer to the second memory space may include executing the trapping function instead of the initial function. For example, program code configured to control operations of the controller (e.g., stored on the controller) may be configured to cause calls to the initial function to be redirected to the trapping function. Alternatively, the initial function may be replaced by the trapping function. By trapping portions of chunks rather than allowing an entire chunk to be stored, particular (e.g., programmed) memory operations of a device may be overridden.

In some embodiments, flushing the particular portion of the chunk from the scratch buffer to the second memory space may include invoking a flash driver, such as an on-board flash driver of a controller (e.g., a controller hosting the scratch buffer and the second memory space). In some embodiments, the controller may invoke the flash driver to flush the particular portion of the chunk from the scratch buffer to the second memory space based on determining that the scratch buffer is full. The trapping function may be configured to invoke the flash driver (i.e., a non-conventional and technically advantageous arrangement). In some disclosed embodiments, the flash driver may be invoked more frequently than when using other techniques, but this processing cost (e.g., a runtime penalty) may be minimal when compared to the resulting compression benefits from the disclosed embodiments.

In some embodiments, process 300 may include determining a chunk size dynamically (e.g., a processor associated with a controller). For example, at least one processor may determine that a memory space is configured to designate a particular size as a page, and may determine a chunk size to apply to software change elements that is a multiple of the particular page size.

As further shown in FIG. 3, process 300 may include flushing the particular portion of the chunk from the scratch buffer to a second memory space (block 306). Flushing a portion of a chunk (e.g., the particular portion or a subsequent portion) may include at least one of transferring the portion (e.g., from the first memory space to the second memory space), transmitting the portion, copying the portion, erasing the portion (e.g., from the first memory space), or storing the portion (e.g., at the second memory space). The second memory space may be distinct from the first memory space. For example, the second memory space may be part of a separate memory component from a memory component of the first memory space. In some embodiments, separate memory components may exist on the same device (e.g., a controller). Alternatively, the second memory space may be a distinct allocation from the first memory space within a singular memory component. In some embodiments, the second memory space may exist in flash memory. In some embodiments, the second memory space may include a different type of memory. For example, the second memory space may include flash memory and the first memory space may include RAM.

As also shown in FIG. 3, process 300 may include storing at least one subsequent portion of the chunk in the scratch buffer (block 308). The at least one subsequent portion of the chunk may include a next portion of the chunk relative to the particular portion (e.g., where the subsequent portion is adjacent to the particular portion when the chunk is represented contiguously). In some embodiments, multiple subsequent portions of a chunk (or multiple chunks) may be stored.

In some embodiments, the particular portion of the chunk and the at least one subsequent portion of the chunk may be sourced from a same set of software change elements (e.g., file). For example, the particular portion of the chunk and the at least one subsequent portion of the chunk may be extracted from a delta file by the controller or other memory-restricted device (e.g., prior to storage at the first memory space).

As further shown in FIG. 3, process 300 may include flushing the at least one subsequent portion of the chunk from the scratch buffer to a second memory space of the controller (block 310). Flushing the at least one subsequent portion of the chunk may be accomplished as described above with respect to the particular portion.

In some embodiments, process 300 may include storing multiple chunks on the scratch buffer and flushing them to the second memory space (e.g., repetitions of blocks 304-310).

As also shown in FIG. 3, process 300 may include applying the software change elements to the controller (block 312). For example, applying the software change elements may include using the flushed first and at least one subsequent portion of the chunk. Additionally or alternatively, applying the software change elements may include changing a first version of software on the controller to a second version of software (e.g., a software update, controller functionality change).

In some embodiments, process 300 may include storing dictionary information in the first memory space according to at least one location determination parameter usable to determine a dictionary information storage location that will increase an overlay region width. Dictionary information may include a data structure (e.g., a table) having multiple parameters (e.g., a variable name, variable value, length parameter, memory location, memory size, or characteristic of at least one software change element) usable by a device (e.g., a controller) to perform a software change operation (e.g., according to process 300). Additionally or alternatively, dictionary information may include metadata associated with received information. The at least one location determination parameter may include one or more of a total region width, a memory space size, a static RAM buffer size, a dictionary size, a call stack size, a data stack size, or any other memory space constraint.

In some embodiments, the dictionary information storage location may be determined within the first memory space (e.g., RAM). For example, the dictionary information storage location may be determined within a static RAM buffer of the first memory space. Determining a dictionary information storage location that will increase an overlay region width may include determining a place within a memory space to store the dictionary information that will result in a larger area (e.g., overlay region width) for storing data (e.g., portions of chunks, software change element information) than an area that would otherwise exist if the place within a memory space to store the dictionary information is static or naively determined.

In some embodiments, process 300 may include dynamically partitioning and overlaying the first memory space. Dynamically partitioning and overlaying the first memory space may include partitioning and overlaying the first memory space depending on particular characteristics of one or more chunks, software change elements (e.g., a software update file), dictionary information, or any other data designated for the first memory space. For example, dynamically partitioning and overlaying the first memory space may be based on metadata associated with the chunk.

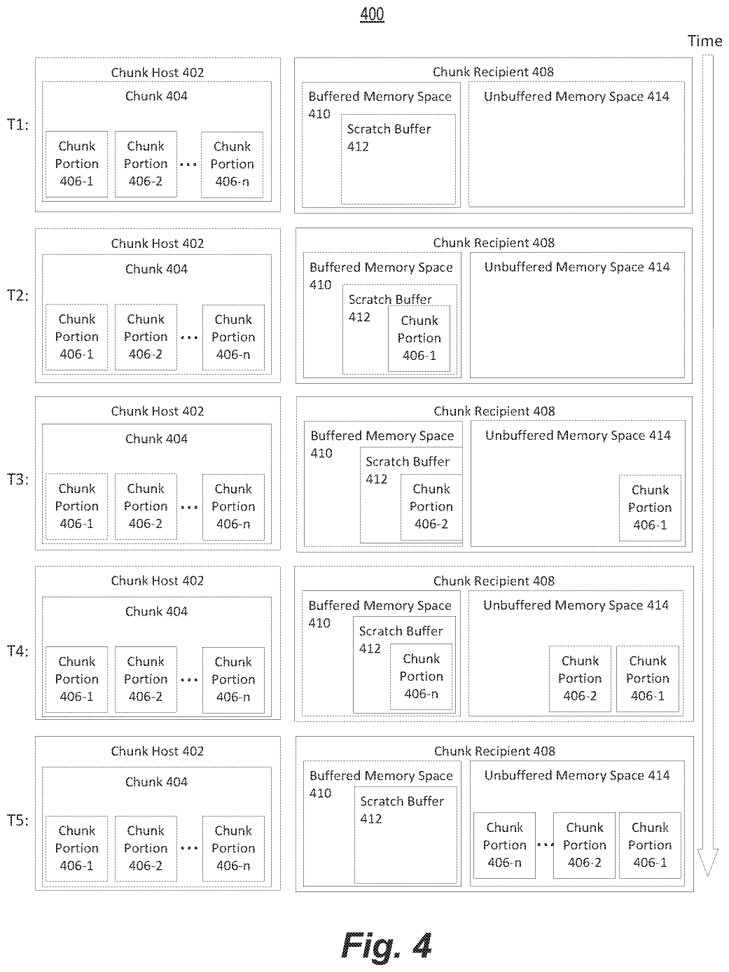

FIG. 4 illustrates an exemplary pictographic temporal representation of a data transfer environment 400. In this environment, a chunk host 402 may store data, such as at least one chunk 404 (while one chunk is depicted, chunk host 402 may store any number of chunks). Chunk host 402 may store data within a storage medium, such as database or hard drive, which may have more storage space than a storage medium of chunk recipient 408, discussed below. In some embodiments, chunk host 402 may be a system 100 or data provider 102. Chunk 404 may be divided (e.g., as it is transmitted) into chunk portions, such as chunk portions 406-1, 406-2, up through 406-n (i.e., chunk 404 may be divided into any number of chunk portions), consistent with disclosed embodiments. In some embodiments, chunk 404 may be associated with (e.g., may be a portion of, may represent, may be configured for an installation process of) software change elements, consistent with disclosed embodiments.

Data transfer environment 400 may also include a chunk recipient 408, which may include one or more memory components and/or memory areas (e.g., memory space 200a and memory space 200b), at which chunk recipient 408 may store data. For example, chunk recipient 408 may include a buffered memory space 410 (e.g., the first memory space discussed above with respect to FIG. 3), within which scratch buffer 412 (e.g., the scratch buffer discussed above with respect to FIG. 3) may be allocated. Chunk recipient 408 may also include an unbuffered memory space 414 (e.g., the second memory space discussed above with respect to FIG. 3). Unbuffered memory space 414 may be larger than buffered memory space 410 and/or scratch buffer 412.

In the example of FIG. 4, at time T1, chunk host 402 may store chunk portions 404-1, 404-2, through 404-n, and chunk recipient 408 may store none of chunk portions 404-1, 404-2, through 404-n. Chunk host 402 may transmit chunk portion 404-1 to chunk recipient 408, such as during a transmission of the entire chunk 404 to chunk recipient 408, such that, at time T2, chunk recipient 408 has received chunk portion 404-1 and stored it in scratch buffer 412. Then, chunk recipient 408 may flush received chunk portion 404-1 to unbuffered memory space 414 (e.g., prior to permitting another chunk portion to be stored in scratch buffer 412). Chunk host 402 may also transmit chunk portion 404-2 to chunk recipient 408, which may occur while chunk recipient 408 flushes received chunk portion 404-1 to unbuffered memory space 414. Chunk recipient 408 may store chunk portion 404-2, transmitted from chunk host 402, at scratch buffer 412, such that, at time T3, chunk portion 404-2 may be stored at scratch buffer 412 and chunk portion 404-1 may be stored at unbuffered memory space 414.

Subsequently, chunk recipient 408 may flush received chunk portion 404-2 to unbuffered memory space 414 (e.g., prior to permitting another chunk portion to be stored in scratch buffer 412). Chunk host 402, which may store and transmit any number of chunk portions and chunks, may also transmit a subsequent chunk portion, such as chunk 404-n, to chunk recipient 408, which may occur while chunk recipient 408 flushes received chunk portion 404-2 to unbuffered memory space 414. Chunk recipient 408 may store chunk portion 404-n, transmitted from chunk host 402, at scratch buffer 412, such that, at time T4, chunk portion 404-n may be stored at scratch buffer 412 and chunk portion 404-2 may be stored at unbuffered memory space 414. Then, chunk recipient 408 may flush received chunk portion 404-n to unbuffered memory space 414, such that chunk recipient 408 stores chunk portions 404-1, 404-2, and 404-n (e.g., all of chunk 404) at unbuffered memory space 414.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways. Unless indicated otherwise, “based on” can include one of more of being dependent upon, being responsive to, being interdependent with, being influenced by, using information from, resulting from, or having a relationship with.

For example, while some embodiments are discussed in a context involving a controller, this element need not be present in each embodiment, as other devices (e.g., embedded devices) may also operate within the disclosed embodiments. Such variations are fully within the scope and spirit of the described embodiments.

The disclosed embodiments may be implemented in a system, a method, and/or a computer program product. The computer program product may include a computer-readable storage medium (or media) having computer-readable program instructions thereon for causing a processor to carry out aspects of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The flowcharts and block diagrams in the Figures illustrate the architecture, functionality, and operation of possible implementations of systems, methods and computer program products according to various embodiments of the present disclosure. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Moreover, some blocks may be executed iteratively, and some blocks may not be executed at all. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials will be developed and the scope of the these terms is intended to include all such new technologies a priori.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A computer-implemented method for improving data compression efficiency for RAM-restricted devices, comprising:
allocating a scratch buffer within a first memory space of a controller;
storing a particular portion of a chunk of software change elements in the scratch buffer;
flushing the particular portion of the chunk from the scratch buffer to a second memory space;
storing at least one subsequent portion of the chunk in the scratch buffer;
flushing the at least one subsequent portion of the chunk from the scratch buffer to a second memory space of the controller; and
applying, using the flushed first and at least one subsequent portion of the chunk, the software change elements to the controller.

2. The computer-implemented method of claim 1, wherein the first memory space exists in random access memory (RAM).

3. The computer-implemented method of claim 1, wherein the second memory space exists in flash memory.

4. The computer-implemented method of claim 3, wherein a size of the chunk is a multiple of a page size associated with the flash memory.

5. The computer-implemented method of claim 3, wherein a size of the scratch buffer is a multiple of a page size associated with the flash memory.

6. The computer-implemented method of claim 1, wherein storing the particular portion of the chunk at the scratch buffer comprises trapping the particular portion of the chunk.

7. The computer-implemented method of claim 6, wherein trapping the particular portion of the chunk comprises executing a trapping function configured to trap chunk portions.

8. The computer-implemented method of claim 7, wherein the trapping function is not configured to trap an entire chunk.

9. The computer-implemented method of claim 7, wherein:
the controller includes an initial function;
the method further comprises storing the trapping function on the controller; and
flushing the particular portion of the chunk from the scratch buffer to the second memory space comprises executing the trapping function instead of the initial function.

10. The computer-implemented method of claim 1, wherein the software change elements include a software change file representing a change to software of the controller.

11. The computer-implemented method of claim 10, wherein the software change elements include a delta file.

12. The computer-implemented method of claim 10, wherein the particular portion of the chunk and the at least one subsequent portion of the chunk are extracted from the delta file by the controller.

13. The computer-implemented method of claim 1, further comprising storing dictionary information in the first memory space according to at least one location determination parameter usable to determine a dictionary information storage location that will increase an overlay region width.

14. The computer-implemented method of claim 1, further comprising dynamically partitioning and overlaying the first memory space.

15. The computer-implemented method of claim 1, wherein dynamically partitioning and overlaying the first memory space is based on metadata associated with the chunk.

16. The computer-implemented method of claim 1, wherein a size of the scratch buffer is smaller than the size of the chunk.

17. The computer-implemented method of claim 1, wherein the chunk is one megabyte or less in size.

18. A non-transitory computer-readable medium storing one or more instructions for improving data compression efficiency for RAM-restricted devices, that, when executed by one or more processors of a device, cause the device to:
allocate a scratch buffer within a first memory space of a controller;
store a particular portion of a chunk of software change elements in the scratch buffer;
flush the particular portion of the chunk from the scratch buffer to a second memory space;
store at least one subsequent portion of the chunk in the scratch buffer;
flush the at least one subsequent portion of the chunk from the scratch buffer to a second memory space of the controller; and
apply, using the flushed first and at least one subsequent portion of the chunk, the software change elements to the controller.

19. The non-transitory computer-readable medium of claim 18, wherein the first memory space exists in random access memory (RAM).

20. The non-transitory computer-readable medium of claim 18, wherein the second memory space exists in flash memory.
